(19) United States
(12) Patent Application Publication
(10) Pub. No.: US 2015/0076917 A1
(43) Pub. Date: Mar. 19, 2015

(54) WIRELESS POWER SUPPLY FOR LOGISTIC SERVICES

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/027,468

(22) Filed: Sep. 16, 2013

(51) Int. Cl. H02J 7/02; H02J 5/00

(52) U.S. Cl. CPC H02J 7/025; H02J 5/005
USPC 307/104

(57) ABSTRACT

The present disclosure may provide an electric transmitter which may be used to provide wireless power transmission (WPT) while using suitable WPT techniques such as pocket-forming. Transmitter may operate as power source for electronic devices used in logistic devices such as, postal services, storage services, shipping services, pizza delivery and the like. Such logistics services may use wired power sources, which are not versatile because immobilize electronic devices while receive charge. In some embodiments, transmitters may include one or more antennas connected to at least one radio frequency integrated circuit (RFIC) and one microcontroller. In other embodiments, transmitters may include a plurality of antennas, a plurality of RFIC or a plurality of controllers. In addition, transmitters may include communications components which may allow for communication to various electronic equipment including phones, computers, GPS and others.

### CROSS-REFERENCES TO RELATED APPLICATIONS

The present disclosure is related to U.S. Non-Provisional Patent application Ser. No. 13/891,430 filed May 10, 2013, entitled “Methodology For Pocket-forming”; Ser. No. 13/925,469 filed Jun. 24, 2013, entitled “Methodology for Multiple Pocket-Forming”; Ser. No. 13/946,082 filed. Jul. 19, 2013, entitled “Method for 3 Dimensional Pocket-forming”; Ser. No. 13/891,399 filed May 10, 2013, entitled “Receivers for Wireless Power Transmission” and Ser. No. 13/891,445 filed May 10, 2013, entitled “Transmitters For Wireless Power Transmission”, the entire contents of which are incorporated herein by these references.

### FIELD OF INVENTION

The present disclosure relates to electronic transmitters and more particularly to transmitters for wireless power transmission in logistic.

### BACKGROUND OF THE INVENTION

Electronic devices used for logistic services such as, laptop computers, phones, radios, GPS, tablets and so forth may require power for performing their intended functions. This may require having to charge electronic equipment at least once a day, or in high-demand electronic devices more than once a day. Such an activity may be difficult while logistic operations may require moving away from the delivery vehicle, stocks and warehouses. In addition, logistic personnel may have to find available power sources to connect to. Lastly, logistic personnel may deploy wires in order to be able to charge his or her electronic devices. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable. For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides wireless charging methods and systems for powering or charging electronic devices used in logistic services. The method may include a type of transmitter which may be employed for sending Radio frequency (RF) signals to electronic devices, such as laptop computers, phones, radios, GPS, tablets and the like. Electronic devices may also include a type of receiver embedded or attached to it for converting RF signals into suitable electricity for powering and charging themselves. The technique employed may be known as pocket-forming and may be incorporated here by reference.

A transmitter including at least two antenna elements may generate RF signals through the use of one or more Radio frequency integrated circuit (RFIC) which may be managed by one or more microcontrollers. Transmitters may receive power from a power source, which may provide enough electricity for a subsequent conversion to RF signal.

According to an embodiment, the transmitter may be located within or outside a delivery vehicle. Transmitter may be powered by a conventional power source such as, diesel plant, photovoltaic cells, turbines and the like. Transmitter in the vehicle may provide a power source for a variety of electronic devices used for delivery services, which may be operated by delivery personnel and may increase operational range of the personnel because the wireless power transmission.

According to an embodiment, the transmitter may be located in a warehouse. Transmitter may be powered by a conventional power source such as, diesel plant, photovoltaic cells, turbines and the like. Transmitter may provide a power source for a variety of electronic devices used for logistic services, which may be operated by logistic personnel and may increase operational range of the personnel because the wireless power transmission.

Transmitter arrangements provided in the present disclosure, as well as possible implementation schemes may provide wireless power transmission while eliminating the use of wires or pads for charging devices which may require tedious procedures such as plugging to a wall, and may turn devices unusable during charging. In addition, electronic equipment may require less components as typical wall chargers may not be required. In some cases, even batteries may be eliminated as a device may fully be powered wirelessly.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a wireless power transmission example situation using pocket-forming in accordance with the present invention.

FIG. 2 illustrates a component level embodiment for a transmitter of FIG. 1.

FIG. 3 illustrates a transmitter arrangement where a delivery vehicle has a transmitter integrated in a side wall of the vehicle.

FIG. 4 illustrates a wireless power transmission arrangement where a transmitter is located in a warehouse.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### Description Of The Drawings

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

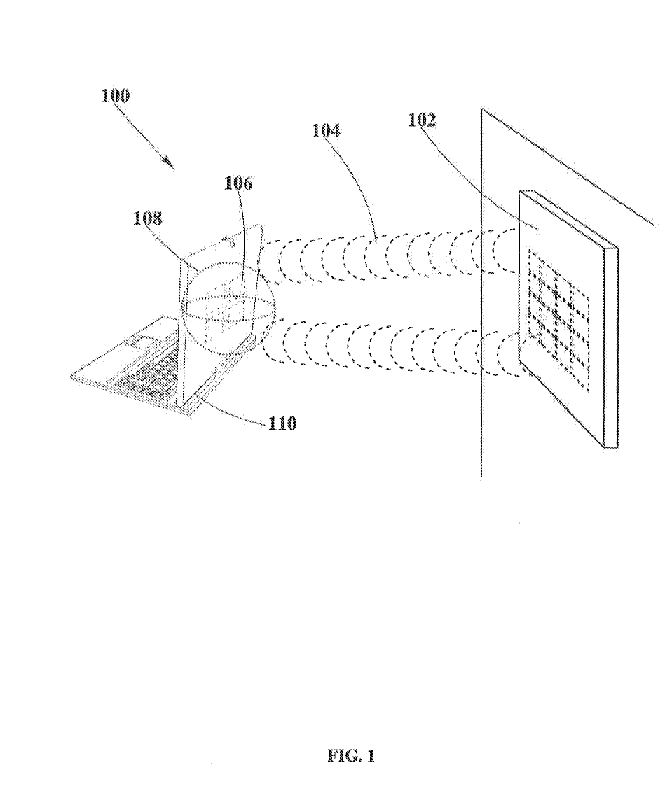

FIG. 1 illustrates wireless power transmission 100 using pocket-forming. A transmitter 102 may transmit controlled Radio (RIF) waves 104 which may converge in 3-d space. These RF waves 104 may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission 100. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

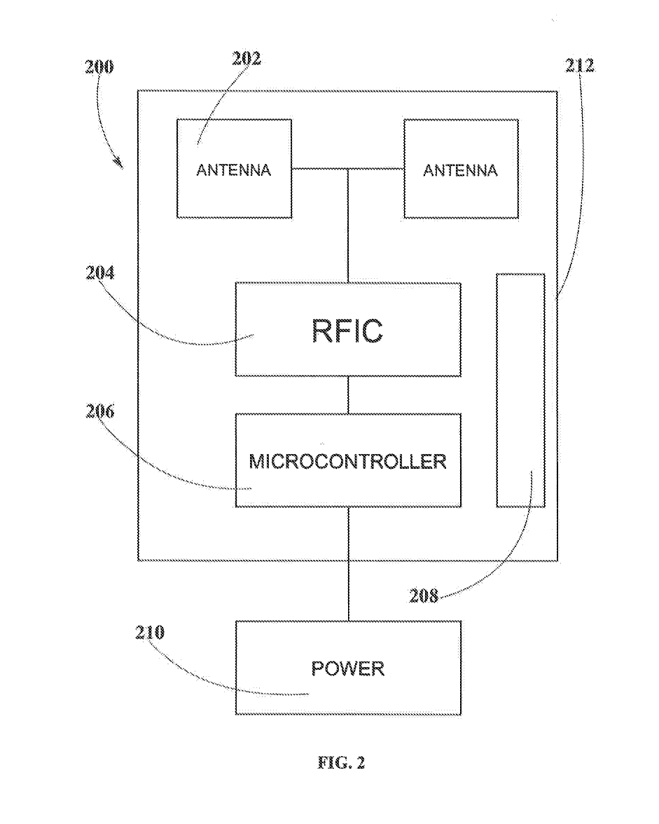

FIG. 2 depicts a basic block diagram of a transmitter 200 which may be utilized for wireless power transmission 100. Such transmitter 200 may include one or more antenna elements 202, one or more Radio frequency integrated circuit (RFIC) 204, one or more microcontroller 206, a communication component 208, a power source 210 and a housing 212, which may allocate all the requested components for transmitter 200. Components in transmitter 200 may be manufactured using meta-materials, micro-printing of circuits, nano-materials, and the like.

Transmitter 200 may be responsible for the pocket-forming, adaptive pocket-forming and multiple pocket-forming through the use of the components mentioned in the foregoing paragraph. Transmitter 200 may send wireless power transmission 100 to one or more receivers 106 in form of radio signals, such signals may include any radio signal with any frequency or wavelength.

Antenna elements 202 may include flat antenna elements 202, patch antenna elements 202, dipole antenna elements 202 and any suitable antenna for wireless power transmission 100. Suitable antenna types may include, for example, patch antennas with heights from about 1/24 inches to about 1 inch and widths from about 1/24 inches to about 1 inch, Shape and orientation of antenna elements 202 may vary in dependency of the desired features of transmitter 200, orientation may be flat in X, Y, and Z axis, as well as various orientation types and combinations in three dimensional arrangements. Antenna elements 202 materials may include any suitable material that may allow Radio signal transmission with high efficiency, good heat dissipation and the like. Number of antenna elements 202 may vary in relation with the desired range and power transmission capability on transmitter 200, the more antenna elements 202, the wider range and higher power transmission capability.

Antenna elements 202 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment), Antenna elements 202 may operate in independent frequencies, allowing a multichannel operation of pocket-forming.

In addition, antenna elements 202 may have at least one polarization or a selection of polarizations. Such polarization may include vertical pole, horizontal pole, circularly polarized, left hand polarized, right hand polarized, or a combination of polarizations. The selection of polarizations may vary in dependency of transmitter 200 characteristics. In addition, antenna elements 202 may be located in various surfaces of transmitter 200.

Antenna elements 202 may operate in single array, pair array, quad array and any other suitable arrangement, which may be designed in accordance with the desired application.

RFIC 204 may include a plurality of RF circuits which may include digital and/or analog components, such as, amplifiers, capacitors, oscillators, piezoelectric crystals and the like. RFIC 204 may control features of antenna elements 202, such as gain and/or phase for pocket-forming and manage it through direction, power level, and the like. The phase and the amplitude of pocket-forming in each antenna elements 202 may be regulated by the corresponding RFIC 204 in order to generate the desired pocket forming and null steering. In addition RFIC 204 may be connected to microcontroller 206, which may include a digital signal processor (DSP), PIC-Class microprocessor, central processing unit, computer and the like. Microcontroller 206 may control a variety of features of RFIC 204 such as, time emission of pocket-forming, direction of the pocket-forming, bounce angle, power intensity and the like. Furthermore, microcontroller 206 may control multiple pocket-forming over multiple receivers 106 or over a single receiver 106. Furthermore, transmitter 200 may allow distance discrimination of wireless power transmission 100.

In addition, microcontroller 206 may manage and control communication protocols and signals by controlling communication component 208. Microcontroller 206 may process information received by communication component 208 which may send and receive signals to and from a receiver 106 in order to track it and concentrate the pocket of energy 108 on it. In addition, other information may be transmitted from and to receiver 106; such information may include authentication protocols among others. Communication component 208 may include and combine Bluetooth technology, infrared communication, WI-FI, FM radio among others. Microcontroller 206 may determine optimum times and locations for pocket-forming, including the most efficient trajectory to transmit pocket forming in order to reduce losses because obstacles. Such trajectory may include direct pocket-forming, bouncing, and distance discrimination of pocket-forming.

Transmitter 200 may be fed by a power source 210 which may include AC or DC power supply. Voltage, power and current intensity provided by power source 210 may vary in dependency with the required power to be transmitted. Conversion of power to radio signal may be managed by microcontroller 206 and carried out by RFIC 204, which may utilize a plurality of methods and components to produce radio signals in a wide variety of frequencies, wavelength, intensities and other features. As an exemplary use of a variety of methods and components for radio signal generation, oscillators and piezoelectric crystals may be used to create and change radio frequencies in different antenna elements 202. In addition, a variety of filters may be used for smoothing signals as well as amplifiers for increasing power to be transmitted.

Transmitter 200 may emit pocket-forming with a power capability from few watts to over hundreds of watts. Each antenna may manage a certain power capacity. Such power capacity may be related with the application.

Antenna elements 202, RFIC 204 and microcontrollers 206 may be connected in a plurality of arrangements and combinations, which may depend on the desired Characteristics of transmitter 200.

Receiver 106 may communicate with transmitter 102 through short RF waves 104 or pilot signals sent through antenna elements 202. In some embodiments, receiver 106 may include an optional communications device for communicating on standard wireless communication protocols such as Bluetooth, Wi-Fi or Zigbee with transmitter 102. In some embodiments, receiver 106 may be implemented externally to electronic devices in the form of cases, e.g. camera cases, phone cases and the like which may connect trough suitable and well known in the art techniques such as universal serial bus (USB). In other embodiments, receiver 106 may be embedded within electronic devices.

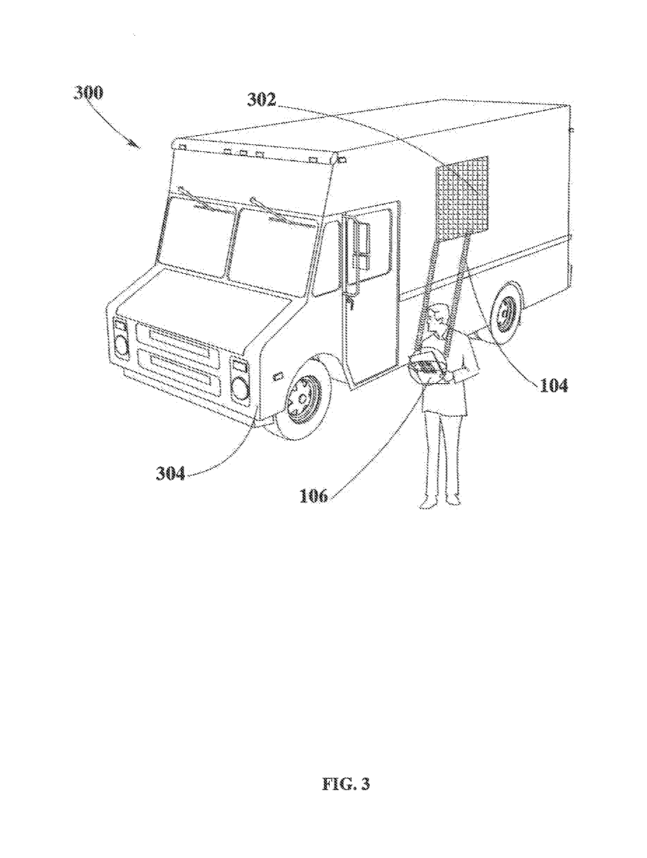

FIG. 3 shows wireless power transmission 300 where a transmitter 302 may be located on or within a delivery vehicle 304, according to an embodiment. Delivery vehicle 304 may be a postal truck, a pizza truck, armored truck for bank services and the like. Transmitter 302 may use a diesel generator as power source 210, other power sources 210 such as, alternator of vehicle 304, photovoltaic cells and the like may be employed too. Transmitter 302 may generate and direct RF waves 104 towards the receivers 106 embedded or attached to electronic devices such as laptops, GPS, radios, cellphones, tablets among others. In addition, transmitter 302 in delivery vehicle 304 may wirelessly extend the life of batteries in the previously mentioned devices during the operation.

Transmitter 302 may be in a door, wall, top of the delivery vehicle 304 and the like. Furthermore, other transmitter 302 configurations may be used in dependency of the region and requirement, such requirement may include transmitter 302 on telescopic mast for increasing range.

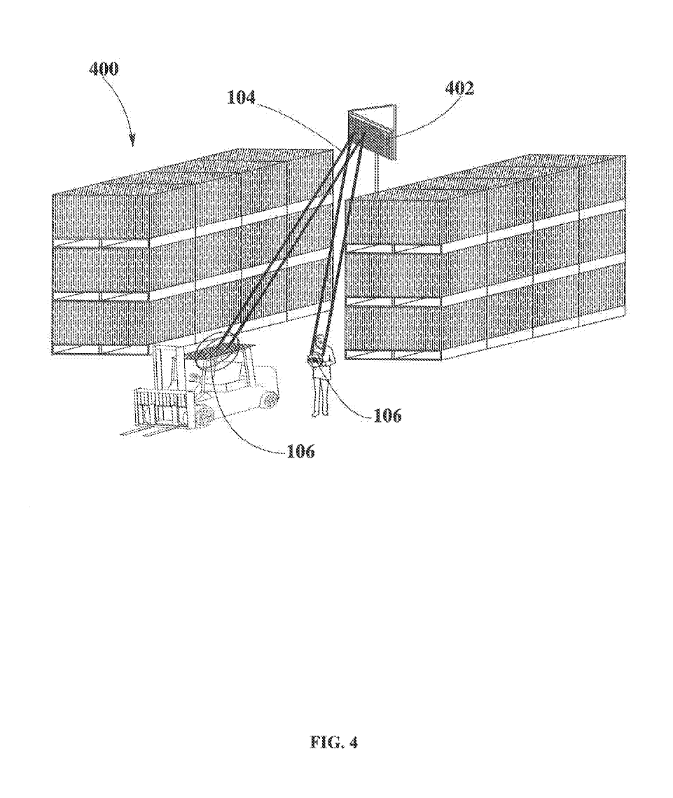

FIG. 4 shows warehouse 400 where one or more transmitters 402 may be located in walls or ceiling for powering and charging electronic devices, such electronic devices may include tablets, laptops, cellphones, radios, lifters, hoists and the like. Transmitter 402 may be connected to an electrical grid which may operate as power source 210, other power sources 210 may be employed too. Transmitter 402 may generate and direct RF waves 104 towards the receivers 106 embedded or attached to electronic devices such as laptops, GPS, radios, cellphones, hoists, tablets among others. In addition, transmitter 402 may wirelessly extend the life of batteries in the previously mentioned devices during the operation.

Transmitter 402 may be in wall, ceiling of the warehouse 400 and the like. Furthermore, other transmitter 402 configurations may be used in dependency of the region and requirement, such requirement may include transmitter 402 on telescopic mast for increasing range.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

1. A method for a wireless power supply for logistic services, comprising:
connecting a pocket-forming transmitter with at least two antennas to a power source;
generating power RF signals from a RF circuit connected to the transmitter to form pockets of energy;
controlling the generated power RF signals with a controller through the RF circuit to provide phase shifting and gain adjusting with respect to other power RF signals or short RF communication signals;
transmitting the power RF and short RF communication signals through the antennas connected to the transmitter;
capturing the pockets of energy in a receiver with an antenna connected to an electronic logistic device to convert the pockets of energy into a DC voltage for charging or powering the electronic logistic device; and
communicating power requirements of the electronic logistics device and the receiver location information between the pocket-forming transmitter and receiver through the short RF signals.

2. The method for a wireless power supply for logistic services, comprising the steps of:
transmitting controlled power RF waves generated by the pocket-forming transmitter to provide pockets of energy that converge in 3-d space to wirelessly charge or power the electronic logistic device.

3. The method for a wireless power supply for logistic services of claim 1, wherein the power source is a diesel generator, a vehicle alternator, photovoltaic cells or a gasoline or natural gas generator or battery.

4. The method for a wireless power supply for logistic services of claim 1, Wherein the transmitter includes a housing suitable for field use, at least two antenna elements, at least one RF integrated circuit, at least one digital signal processor and a communication component for generating the power RF and short RF signals, respectively.

5. The method for a wireless power supply for logistic services of claim 3, wherein the transmitter is located in a door, on a side or on top of a vehicle like a truck.

6. The method for a wireless power supply for logistic services of claim 5, further including the step of extending the transmission distance of the pocket-forming transmitter by mounting the pocket-forming transmitter a predetermined height with a telescopic mast connected to a top surface of a vehicle including a postal truck, an armored truck or other deliver truck to power the electronic logistic devices.

7. The method for a wireless power supply for logistic services of claim 4, wherein the receiver communicates to the transmitter through short RF signals sent through antenna elements within the receiver to the antenna elements of the transmitter.

8. The method for a wireless power supply for logistic services of claim 4, wherein the short RF signals are standard wireless communication protocols including Bluetooth, Wi-Fi, ZigBee or FM radio.

9. The method for a wireless power supply for logistic services of claim 2, further includes the step of utilizing adaptive pocket-forming to regulate the pockets of energy transmitted by the pocket-forming transmitter to power the electronic logistic device such as a GPS, radios, cellphones, tablets to extend the life of the batteries in the device.

10. The method for a wireless power supply for logistic services of claim 1, further including the step of coupling the pocket-forming transmitter to a mobile generator of power wherein the transmitter protrudes a predetermined distance above the generator or vehicle in which the generator is located on a telescopic mast to extend the range of the transmitter to power electronic logistic device.

11. The method for a wireless power supply for logistic services of claim 1, wherein the transmitter includes a housing in a triangular or circular configuration to provide omni-directional transmitting of controlled power RF waves from the pocket-forming transmitter to generate pockets of energy that converge in 3-d space to wirelessly charge or power electronic logistic device in the field.

12. The method for a wireless power supply for logistic services of claim 1, wherein the receiver is embedded in the electronic logistic device to continue the powering of the electronic logistic device when transmitting communication signals from the electronic logistic device to the transmitter for providing information to an end user in a warehouse to power laptops, cellphones, radios, lifters, hoists, tablets and other electronic logistic device for warehousing.

13. A wireless power supply for logistic services, comprising:
a transmitter for pocket-forming to send controlled radio frequency power waves to converge into pockets of energy in 3-d space;
a power source connected to the transmitter for powering the transmitter; and
a receiver embedded in an electronic logistic device for capturing the pockets of energy to charge or power the electronic logistic device connected to the receiver.

14. The wireless power supply for logistic services of claim 13, wherein the transmitter is mounted to a stationary or mobile power source.

15. The wireless power supply for logistic services of claim 13, wherein the mobile power source is a portable generator running on diesel, gas, alternator or battery energy.

16. The wireless power supply for logistic services of claim 13, further includes a telescopic mast or pole for mounting the transmitter a predetermined height above the clutter of a warehouse, truck loading docks, railroad yards, shipping ports or piers or airports.

17. The wireless power supply for logistic services of claim 14, wherein the pocket-forming transmitter includes a triangular, square or circular housing with antenna elements on the surface for omni-directional transmission of the power waves to extend the range of transmitting pockets of energy to the receivers of the electronic logistic devices in a staging area for shipments or deliveries.

18. The wireless power supply for logistic services of claim 13, wherein the pocket-forming transmitter communicates with the receiver through short RF signals over standard wireless communication protocols including Bluetooth, Wi-Fi, ZigBee or FM radio.

19. A wireless power supply for logistic services, comprising:
a pocket-forming transmitter for transmitting power RF waves to form pockets of energy to charge an electronic logistic device;
a mobile or stationary power source coupled to the transmitter for powering the pocket-forming transmitter; and
a receiver connected to or embedded within the electronic logistic device for capturing the pockets of energy converging in 3-d space to charge or power the electronic logistic device operating and communicate in a service locations for delivery vehicles or warehousing operations and to communicate with a base station with operation information for a business.

20. The wireless power supply for logistic services of claim 19, wherein the receiver and transmitter both include a communications component within the receiver and transmitter for communicating with each other and with the base station to wirelessly power or charge the electronic logistic device during the operations.
